(19) United States
(12) Patent Application Publication
(10) Pub. No.: US 2023/0044105 A1
(43) Pub. Date: Feb. 9, 2023

(54) MOTOR

(71) Applicant: Nidec Corporation, Kyoto (JP)

(72) Inventor: Shigeharu SUMI, Kyoto (JP)

(21) Appl. No.: 17/879,064

(22) Filed: Aug. 2, 2022

(30) Foreign Application Priority Data
Aug. 5, 2021 (JP) 2021-129192

(51) Int. Cl. H02K 9/22; H02K 5/18; H02K 9/20

(52) U.S. Cl. CPC H02K 9/225; H02K 5/18; H02K 9/20

(57) ABSTRACT

A motor includes a rotor that is rotatable about a central axis and a stator that radially opposes the rotor with a gap interposed therebetween. The stator includes a stator core that includes an annular core back surrounding the central axis and a tooth extending to a radially inner side from the core back, and a coil that is wound around the tooth. The stator core includes at least one hole penetrating in an axial direction of the central axis, and a slit including a space connecting the hole and a radially outer side of the stator core. A heat pipe is held in the hole and extends in an axial direction along the hole, and an adhesive is between the hole and the heat pipe.

### CROSS-REFERENCE TO RELATED APPLICATIONS

The present application claims priority under 35 U.S.C. §119 to Japanese Patent Application No. 2021-129192, filed on Aug. 5, 2021, the entire contents of which are hereby incorporated herein by reference.

### 1. FIELD OF THE INVENTION

The present disclosure relates to a motor.

### 2. BACKGROUND

In a motor, heat generated by a coil cannot be sufficiently dissipated via a motor housing or the like, and an upper limit of a motor output reaches a peak due to a temperature rise of the coil due to the heat generation. In this regard, the output of a motor having the same size is increased by lowering a thermal resistance.

Conventionally, it is known that a heat pipe extending in a rotation axis direction is arranged in a gap between a core back of a stator core and a coil to dissipate the heat generated by the coil.

However, in the conventional configuration, it is difficult to stably fix the heat pipe, and thus there is a possibility that the insulation film of the coil is damaged at a portion where the heat pipe and the coil are brought into contact with each other. In addition, in the conventional configuration, it is difficult to sufficiently cool the region of the coil protruding from the stator core in the rotation axis direction of the coil.

### SUMMARY

According to an example embodiment of the present disclosure, a motor includes a rotor that is rotatable about a central axis, and a stator that radially opposes the rotor with a gap interposed therebetween. The stator includes a stator core that includes an annular core back surrounding the central axis and a tooth extending to a radially inner side from the core back, and a coil that is wound around the tooth. The stator core includes at least one hole penetrating in an axial direction of the central axis, and a slit that defines a space connecting the hole and a radially outer side of the stator core. The motor further includes a heat pipe that is held in the hole and extends in an axial direction along the hole and an adhesive that is between the hole and the heat pipe.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view schematically illustrating a motor according to a first example embodiment of the present disclosure.

FIG. 2 is an external perspective view illustrating a portion of a stator of the first example embodiment.

FIG. 3 is a cross-sectional view illustrating a portion of the stator of the first example embodiment and is a cross-sectional view taken along line II-II in FIG. 1.

FIG. 4 is an enlarged view of a hole HL and a stator core 20 in FIG. 3.

FIG. 5 is a cross-sectional view schematically illustrating a motor according to a second example embodiment of the present disclosure.

FIG. 6 is an external perspective view of a heat dissipation portion 60 and a rear cone portion 103 according to an example embodiment of the present disclosure.

FIG. 7 is an external perspective view of a fin according to an example embodiment of the present disclosure.

FIG. 8 is a longitudinal sectional view of the fin.

FIG. 9 is an external perspective view illustrating a procedure of attaching a fin 62 and a heat pipe 50 to an attachment portion 70 according to an example embodiment of the present disclosure.

FIG. 10 is an external perspective view 10 illustrating the fin 62 according to a modification of the second example embodiment.

FIG. 11 is a view illustrating an action of sucking out internal air from the fin 62 by an airflow flowing outside the fin 62 according to an example embodiment of the present disclosure.

FIG. 12 is a cross-sectional view schematically illustrating a motor according to a third example embodiment of the present disclosure.

FIG. 13 is a cross-sectional view taken along line III-III in FIG. 12.

### DETAILED DESCRIPTION

Hereinafter, motors according to example embodiments of the present disclosure will be described with reference to the accompanying drawings. Note that the scope of the present disclosure is not limited to the example embodiments described below, but includes any modification thereof within the scope of the technical idea of the present disclosure. In addition, there is a case where scales, numbers, and the like of structures illustrated in the following drawings may differ from those of actual structures, for the sake of easier understanding of the structures.

A Z-axis direction appropriately illustrated in each drawing is a vertical direction in which a positive side is an "upper side" and a negative side is a "lower side". A central axis J appropriately illustrated in each drawing is a virtual line that is parallel to the Z-axis direction and extends in the vertical direction. In the following description, an axial direction of the central axis J, that is, a direction parallel to the vertical direction, is simply referred to as "axial direction", a radial direction around the central axis J is simply referred to as "radial direction", and a circumferential direction around the central axis J is simply referred to as "circumferential direction".

The vertical direction, the upper side, and the lower side are merely terms for describing a relative positional relationship between the respective units, and an actual layout relationship and the like may be other than the layout relationship represented by these terms.

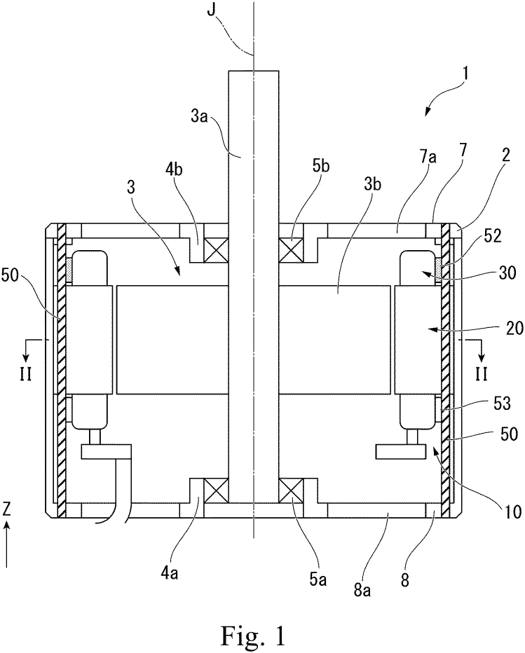

As illustrated in FIG. 1, a motor 1 of a first example embodiment is an inner rotor type motor. The central axis of the motor 1 is the central axis J. The motor 1 includes a housing 2, a rotor 3, a stator 10, bearings 5a and 5b, and a heat pipe 50. The housing 2 accommodates the rotor 3, the stator 10, and the bearings 5a and 5b. The rotor 3 is rotatable about the central axis J. The rotor 3 includes a shaft 3a and a rotor main body 3b.

The housing 2 has a lid portion 7 and a bottom plate portion 8. The lid portion 7 has a through hole 7a. The through hole 7a penetrates the lid portion 7 in the axial direction. A plurality of through holes 7a are provided at intervals in the circumferential direction. The bottom plate portion 8 has a through hole 8a. The through hole 8a penetrates the bottom plate portion 8 in the axial direction. A plurality of through holes 8a are provided at intervals in the circumferential direction.

The shaft 3a extends in the axial direction along the central axis J. The shaft 3a has, for example, a columnar shape that is centered on the central axis J and extends in the axial direction. The shaft 3a is supported by the bearings 5a and 5b to be rotatable about the central axis J. The bearings 5a and 5b are held by bearing holders 4a and 4b of the housing 2. The rotor main body 3b is fixed to an outer peripheral surface of the shaft 3a. Although not illustrated, the rotor main body 3b includes a rotor core fixed to the outer peripheral surface of the shaft 3a and a magnet fixed to the rotor core.

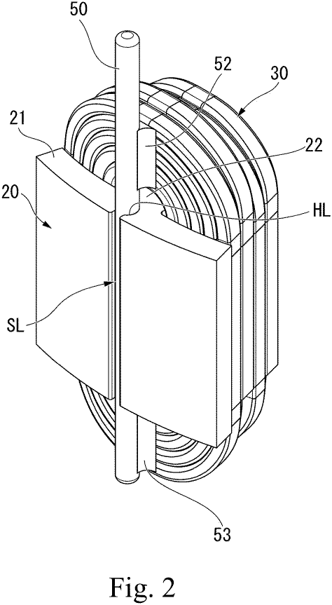

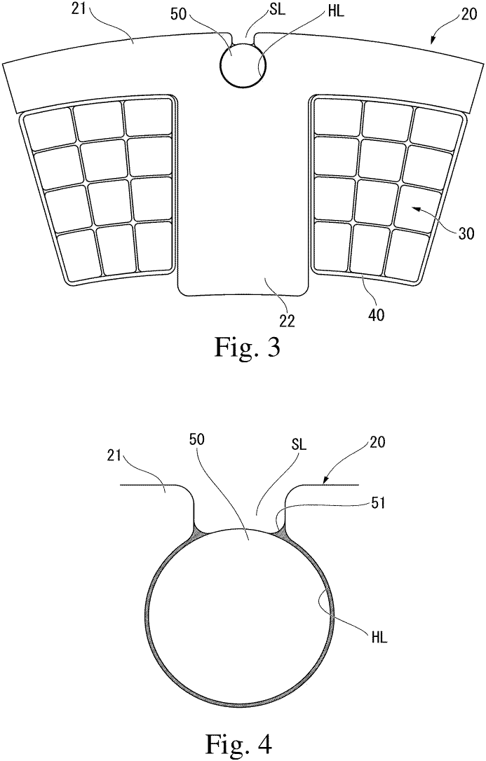

The stator 10 faces the rotor 3 in the radial direction with a gap interposed therebetween. In the present example embodiment, the stator 10 is located on the radially outer side of the rotor 3. As illustrated in FIGS. 2 and 3, the stator 10 includes a stator core 20, a plurality of coils 30, and an insulator 40 (not illustrated in FIG. 2). The stator core 20 includes an annular core back 21 surrounding the central axis J and a plurality of teeth 22 extending to a radially inner side from the core back 21. The core back 21 has, for example, a cylindrical shape centered on the central axis J.

The plurality of teeth 22 are arranged at intervals along the circumferential direction. The plurality of teeth 22 are arranged at equal intervals over the entire circumference along the circumferential direction, for example. In the present example embodiment, the plurality of teeth 22 are formed integrally with the core back 21. Each of the teeth 22 has a substantially rectangular parallelepiped shape extending linearly along the radial direction. The circumferential dimension of the tooth 22 is substantially constant over the entire radial direction.

Note that the radially inner end portion of the tooth 22 may be provided with umbrella portions protruding to both circumferential sides. In addition, the tooth 22 may be a member separate from the core back 21. In this case, the tooth 22 may be fixed to the core back 21, for example, by press-fitting a protrusion provided at end portions on the radially outer side of the tooth 22 into a concave portion provided on the radially inner surface of the core back 21.

The plurality of coils 30 are attached to the plurality of teeth 22, respectively. In the present example embodiment, the coil 30 are attached to the tooth 22 via the insulator 40. Each tooth 22 passes through the inside of each coil 30 in the radial direction. The radially inner end portion of the tooth 22 protrudes to the radially inner side from the coil 30.

As an example, the coil 30 is configured by winding a flat wire. Therefore, the space factor of the coil 30 can be improved as compared with the case of using a round wire. In the present specification, the "flat wire" is a wire rod of which a cross-sectional shape is a quadrangular shape or a substantially quadrangular shape. In the present specification, the term "substantially quadrangular shape" includes a rounded quadrangular shape in which the corners of a quadrangular shape are rounded. Although not illustrated, the flat wire configuring the coil 30 in the present example embodiment is an enameled wire having an enamel coating on the surface.

The stator core 20 of the present example embodiment has at least one hole HL and a slit SL. The hole HL penetrates the stator core 20 in the axial direction. A plurality of holes HL is arranged at intervals along the circumferential direction. For example, the plurality of holes HL are arranged at equal intervals over one circumference along the circumferential direction. The hole HL is arranged in the core back 21. The plurality of holes HL overlap the teeth 22 in the radial direction, respectively. The hole HL is provided for each of the teeth 22. The circumferential center position of the hole HL is the same as the circumferential center position of the tooth 22. The radially outermost position of the hole HL is located on the radially inner side from the outer periphery of the stator core 20. The heat pipe 50 is held in the hole HL. Since the radially outermost position of the hole HL is located on the radially inner side from the outer periphery of the stator core 20, a distance between the coil 30 and the heat pipe 50 can be shortened, and heat from the coil 30 can be efficiently released to the heat pipe 50.

The slit SL is a space connecting the hole HL and the radially outer side of the stator core 20. The slit SL extends in the axial direction. The circumferential width of the slit SL is smaller than the diameter of the heat pipe 50. Since the circumferential width of the slit SL is smaller than the diameter of the heat pipe 50, it is possible to suppress the heat pipe 50 held in the hole HL from coming out radially outward through the slit SL.

The heat pipe 50 is a heat conducting element. The heat pipe 50 has a shaft-shaped sealed container which is sealed with a working fluid in a decompressed state. The heat pipe 50 has a capillary structure (wick) on an inner wall of the sealed container. The heat pipe 50 is held by each of the plurality of holes HL. The number of poles of the stator core 20 of the present example embodiment is twelve. Twelve heat pipes 50 are arranged at equal intervals (30° interval) in the circumferential direction. As illustrated in FIG. 4, an adhesive 51 is filled between the heat pipe 50 and the hole HL. As the adhesive 51, an adhesive having a high thermal conductivity is used.

In a case where the heat pipe 50 is fixed to the hole HL of the stator core 20 not provided with the slit SL with the adhesive 51, it is difficult to fill the adhesive 51 between the hole HL and the heat pipe 50, and a gap may be generated. For example, when the adhesive 51 is applied to the inner peripheral surface of the hole HL in advance, and the heat pipe 50 is inserted into the hole HL, the adhesive 51 is pushed out. For example, when the adhesive 51 is applied to the outer peripheral surface of the heat pipe 50, and the heat pipe 50 is inserted into the hole HL, the adhesive 51 is scraped off by being squeezed at the insertion side end portion of the hole HL. Therefore, the space between the heat pipe 50 and the hole HL cannot be sufficiently filled with the adhesive 51. In this case, the holding property of the heat pipe 50 to the stator core 20 is reduced, and air exists which has a thermal resistance larger than that in a state where the adhesive 51 is filled between the hole HL and the heat pipe 50, so that a heat transfer efficiency is reduced.

On the other hand, in the present example embodiment, the slit SL connecting the hole HL and the radially outer side of the stator core 20 is provided, and thus the adhesive 51 is applied to the heat pipe 50 inserted into the hole HL via the slit SL, so that the adhesive 51 can be easily and sufficiently spread and filled between the hole HL and the heat pipe 50. By filling the space between the hole HL and the heat pipe 50 with the adhesive 51 without any gap, the thermal resistance is reduced, and the heat transfer efficiency is improved.

The heat pipe 50 is longer than the stator core 20 in the axial direction. As illustrated in FIG. 2, the heat pipe 50 protrudes to the upper side and the lower side of the stator core 20. As illustrated in FIG. 1, a part of the heat pipe 50 is in contact with the housing 2. An upper end and a lower end of the heat pipe 50 are in contact with the housing 2. When the end portion of the heat pipe 50 is in contact with the housing 2, the absorbed heat can be effectively dissipated through the housing 2, and the heat dissipation efficiency is improved.

An adhesive 52 is applied between the heat pipe 50 protruding to the upper side of the stator core 20 and the coil 30. The adhesive 52 connects the heat pipe 50 protruding to the upper side and the coil 30. The heat generated in the coil 30 located above the stator core 20 is transferred to the heat pipe 50 via the adhesive 52. An adhesive 53 is applied between the heat pipe 50 protruding to the lower side of the stator core 20 and the coil 30. The adhesive 53 connects the heat pipe 50 protruding to the lower side and the coil 30. The heat generated in the coil 30 located on the lower side of the stator core 20 is transferred to the heat pipe 50 via the adhesive 53. An adhesive having a high thermal conductivity is used as the adhesives 52 and 53. The adhesives 52 and 53 may be the same material as the adhesive 51 or may be different materials.

Alternatively, instead of the adhesives 52 and 53, a heat removing member may be manufactured as a separate component by using a material such as metal having a thermal conductivity higher than the of the adhesive, and the heat removing member may be interposed between the heat pipe 50 and the coil 30. In this case, the heat removing member can be fixed to the heat pipe 50 and the coil 30 with an adhesive. Even when the adhesives 52 and 53 having a high thermal conductivity are used, the thermal conductivity is on the order of 1/10 to 1/100 as compared with, for example, an aluminum material as a metal. Therefore, by using the heat removing member made of a material such as metal, the thermal resistance can be further reduced, and the heat of the coil 30 can be effectively removed.

In the heat pipe 50, the heat generated in the coil 30 is transferred in the region held in the hole HL of the stator core 20 and the region to which the adhesives 52 and 53 are applied, and the regions become high-temperature regions. The heat of the heat pipe 50 in a high-temperature region is removed by the heat of vaporization when the internal working fluid evaporates. Therefore, in the heat pipe 50, the region held in the hole HL of the stator core 20 and the region to which the adhesives 52 and 53 are applied are heat removal regions. The working fluid evaporated inside the heat pipe 50 releases heat in a low-temperature region to be liquefied. The working fluid evaporated inside the heat pipe 50 releases heat and liquefies in a low-temperature region in contact with the housing 2. Therefore, in the heat pipe 50, in particular, a region in contact with the housing 2 is a heat dissipation region. The working fluid liquefied in the heat dissipation region moves to the high-temperature region by the capillary structure.

In the present example embodiment, the heat pipe 50 is not in direct contact with the coil 30, and thus the insulation film of the coil 30 is not damaged. Since the adhesive 51 can be sufficiently spread and filled between the hole HL and the heat pipe 50, the thermal resistance is reduced, and the heat generated in the coil 30 can be sufficiently dissipated. In a case where the heat generated in the coil 30 cannot be sufficiently dissipated, the upper limit of the output of the motor 1 is limited by the temperature rise of the coil 30. In the present example embodiment, by sufficiently dissipating the heat generated in the coil 30, the limitation due to the temperature rise of the coil 30 is alleviated, and the output can be increased by the motor 1 having the same size and specification.

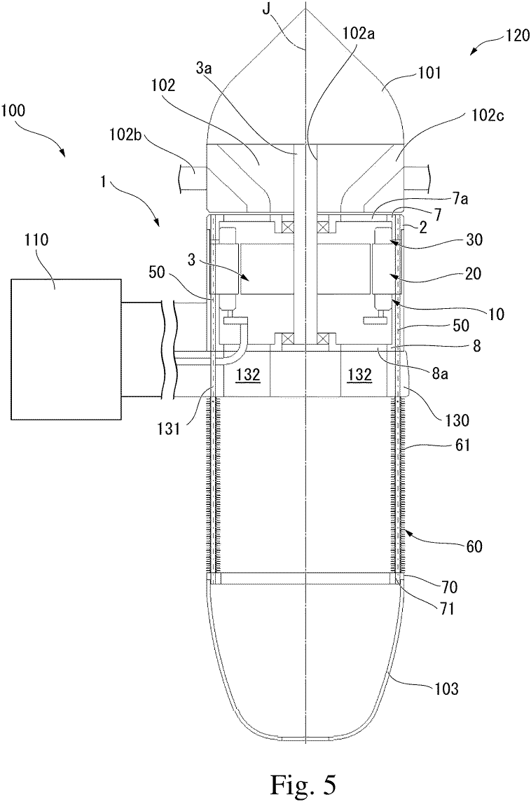

Next, a second example embodiment of the motor 1 will be described with reference to FIGS. 5 to 11.

In these drawings, the same elements as the components of the first example embodiment illustrated in FIGS. 1 to 4 are denoted by the same reference signs, and the description thereof may be omitted. In the motor 1 of the second example embodiment, the central axis J is arranged in the horizontal direction. However, when an arrangement relationship or the like of each portion is described, in the Z-axis direction, a positive side is an "upper side", and a negative side is a "lower side".

As illustrated in FIG. 5, the motor 1 of the second example embodiment is provided in an electric airplane 100. The electric airplane 100 includes a main body 110, a rotary blade device 120, and an attachment portion 130. The attachment portion 130 extends from the main body 110 in a direction orthogonal to the axial direction. The rotary blade device 120 is attached to the attachment portion 130. The rotary blade device 120 is a device that generates a propulsive force toward the upper side of the electric airplane 100. In the present example embodiment, a plurality of the rotary blade devices 120 are provided.

The rotary blade device 120 includes the motor 1, a front cone portion 101, a rotary blade portion 102, and a rear cone portion 103. The rotary blade portion 102 is provided with a gap on the axially upper side of the housing 2. The rotary blade portion 102 has an annular shape centered on the central axis J. The rotary blade portion 102 has a through hole 102a, a propeller 102b, and a suction hole 102c.

The through hole 102a penetrates the rotary blade portion 102 in the axial direction. The through hole 102a is coaxial with the central axis J. The upper end of the shaft 3a is inserted into the through hole 102a. The shaft 3a inserted into the through hole 102a is fixed to the rotary blade portion 102. The rotary blade portion 102 fixed to the shaft 3a rotates in synchronization with the rotor main body 3b.

The propeller 102b extends radially outward from the outer peripheral surface of the rotary blade portion 102. A plurality of propellers 102b are provided at intervals in the circumferential direction. The suction hole 102c sucks air from the outside. The suction hole 102c is provided for each of the plurality of propellers 102b. The position of the suction hole 102c in the circumferential direction is the same as the position of the propeller 102b in the circumferential direction. The upper end of the suction hole 102c is open on the upper side of the propeller 102b on the outer peripheral surface of the rotary blade portion 102. The suction hole 102c extends downward from the upper end toward the radially inner side. The lower end of the suction hole 102c is open on the lower surface of the rotary blade portion 102. The position of the lower end of the suction hole 102c is a position facing the through hole 7a of the housing 2 in the axial direction when the rotary blade portion 102 rotates. The air sucked from the upper end of the suction hole 102c can flow into the housing 2 from the lower end of the suction hole 102c through the through hole 7a.

The housing 2 of the motor 1 is attached to the upper side of the attachment portion 130. The attachment portion 130 has a through hole 131 and a through hole 132. The through hole 131 penetrates the attachment portion 130 in the axial direction. The through hole 131 is provided at a position facing the hole HL and the heat pipe 50 in the axial direction. The through hole 131 holds the heat pipe 50. The heat pipe 50 is inserted through the through hole 131. The through hole 132 penetrates the attachment portion 130 in the axial direction. The through hole 132 overlaps the through hole 8a of the bottom plate portion 8 in the axial direction. Since the through hole 132 overlaps the through hole 8a of the bottom plate portion 8 in the axial direction, the air flowing into the housing 2 from the suction hole 102c can flow into the through hole 132 of the attachment portion 130 via the through hole 8a of the bottom plate portion 8.

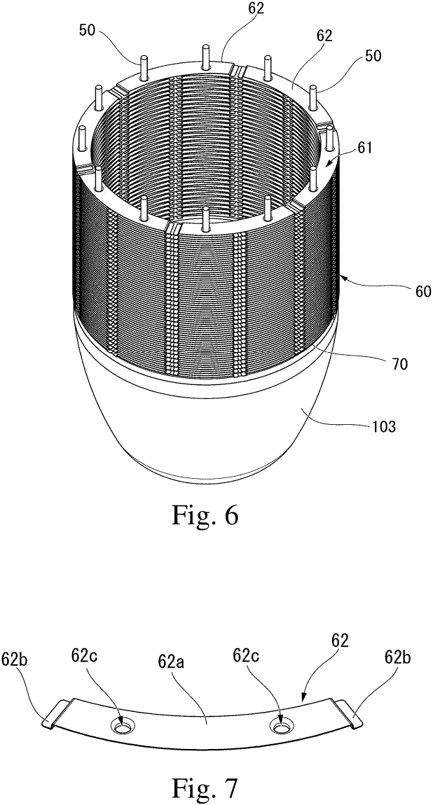

The motor 1 includes a heat dissipation portion 60 and an attachment portion 70. The heat dissipation portion 60 is arranged via the attachment portion 130 on the lower side which is one side in the axial direction of the housing 2. The heat dissipation portion 60 has a plurality of layers of fin portions 61 arranged in the axial direction. As illustrated in FIG. 6, the fin portion 61 of each layer has an annular shape extending in the circumferential direction. The fin portion 61 of each layer has a plurality of fins 62 obtained by equally dividing the fin portion in the circumferential direction. The fin portion 61 of each layer has six fins 62 obtained by equally dividing the fin portion into six parts in the circumferential direction. The circumferential angle of the fin 62 is 60° by which the entire circumference is divided into six equal parts. In the plurality of fins 62, the diameter dimension of the inner periphery is the same as the diameter dimension of the outer periphery. When the diameter dimension of the inner periphery is made the same as the diameter dimension of the outer periphery of the plurality of fins 62, it is possible to manufacture the fins 62 from an annular material without any gap and to reduce material loss.

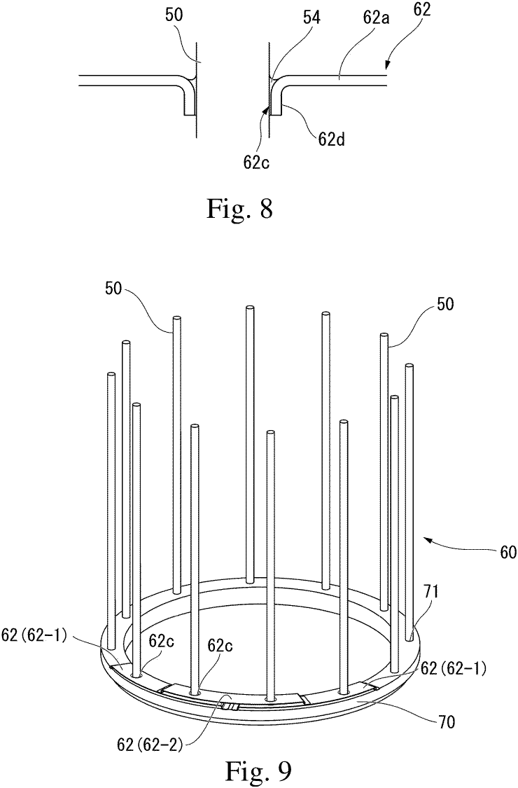

As illustrated in FIG. 7, the fin 62 has a fin body 62a and a flange portion 62b. The fin body 62a has a through hole 62c penetrating in the axial direction. Two through holes 62c are provided at intervals in the circumferential direction. The center positions of the through holes 62c are positions on both circumferential sides 15° away from the circumferential center of the fins 62. The center positions of the two through holes 62c are separated by 30° in the circumferential direction. As illustrated in FIG. 8, the fin body 62a has a boss 62d protruding downward. The boss 62d is coaxial with the through hole 62c. The through hole 62c penetrates the fin body 62a in the axial direction including the boss 62d. In the fin portion 61 of each layer, the heat pipe 50 is inserted through the through hole 62c of the fin 62. The heat pipe 50 inserted through the through hole 62c is fixed to the fin 62 by an adhesive 54. As the adhesive 54, an adhesive having a high thermal conductivity is used.

The flange portions 62b are provided at both circumferential end positions of the fin body 62a. The flange portion 62b is located on the lower side of the fin body 62a. The flange portion 62b is parallel to the fin body 62a. Two flange portions 62b have the same axial distance from the fin body 62a.

As illustrated in FIG. 9, the attachment portion 70 has an annular shape centered on the central axis J. The diameter dimension of the inner peripheral surface of the attachment portion 70 is the diameter dimension of the inner periphery of the fin 62. The diameter dimension of the outer peripheral surface of the attachment portion 70 is the diameter dimension of the outer periphery of the fin 62. The diameter dimension of the inner peripheral surface of the attachment portion 70 and the diameter dimension of the inner periphery of the fin 62 are larger than the diameter dimension of the through hole 132 of the attachment portion 130 on the outermost side in the radial direction. Therefore, the air flowing into the housing 2 from the suction hole 102c can flow into the internal space of the heat dissipation portion 60 via the through hole 8a of the bottom plate portion 8 and the through hole 132 of the attachment portion 130. The air flowing into the internal space of the heat dissipation portion 60 from the suction hole 102c via the inside of the housing 2 can be exhausted to the outside from the gap between the fins 62. Therefore, the heat generated in the coil 30 can be removed by heat exchange with the air sucked through the suction hole 102c in addition to the heat removal by the heat pipe 50.

The attachment portion 70 has a plurality of through holes 71. Twelve through holes 71 are provided at a pitch of 30° in the circumferential direction. The through hole 71 penetrates the attachment portion 70 in the axial direction. The position of the through hole 71 in the radial direction is the same as the position of the hole HL in the radial direction. The lower end side of the heat pipe 50 is inserted through the through hole 71. As illustrated in FIG. 5, the lower end of the heat pipe 50 is in contact with the upper surface of the rear cone portion 103. The heat pipe 50 inserted through the through hole 71 extends upward such that an upper end is in contact with the housing 2.

That is, the heat pipe 50 penetrates the heat dissipation portion 60.

In a case where the central axis J and the heat pipe 50 are arranged in the horizontal direction, the influence of gravity acting on the working fluid in the heat pipe 50 is small. Therefore, the working fluid liquefied in the heat dissipation region can move to the heat removal region more easily compared with a case where the central axis J and the heat pipe 50 are arranged in the vertical direction. As a result, even in a case where the heat pipe 50 is provided to have such a length that penetrates the heat dissipation portion 60, the movement of the working fluid from the heat dissipation region to the heat removal region is hardly hindered.

The heat pipe 50 penetrates the heat dissipation portion 60 so that the heat pipe can dissipate, as a heat dissipation region, heat over the entire axial direction of the heat dissipation portion 60. Therefore, the heat generated by the coil 30 can be effectively dissipated by the heat dissipation portion 60. Since the boss 62d is provided in the penetrating portion (through hole 62c) of the heat pipe 50, the mechanical strength of the fin 62 is improved. Since the boss 62d is provided in the penetrating portion (through hole 62c) of the heat pipe 50, the contact area of the fin 62 with the heat pipe 50 increases. Therefore, the heat dissipation efficiency of the heat pipe 50 can be improved.

The fins 62 are stacked to be arranged in a plurality of layers in the axial direction on the upper side of the attachment portion 70. The fins 62 in the fin portions 61 adjacent to each other in the axial direction are shifted by a half pitch from each other in the circumferential direction and overlap each other in the axial direction. Specifically, as illustrated in FIG. 9, a first layer of the fin 62 (indicated by reference sign 62-1) and a second layer of the fin 62 (indicated by reference sign 62-2) are arranged to be shifted by 30°, which is a half pitch, from each other in the circumferential direction.

When the first layer of six fins 62-1 is arranged in the circumferential direction, the through holes 62c of the fins 62-1 are arranged at intervals of 30° in the circumferential direction. When the second layer of six fins 62-2 is arranged in the circumferential direction, the through holes 62c of the fins 62-2 are arranged at intervals of 30° in the circumferential direction. The first layer of the fins 62-1 and the second layer of the fins 62-2 are arranged to be shifted by 30° in the circumferential direction. Therefore, the through hole 62c of the fin 62-1 and the through hole 62c of the fin 62-2 overlap each other in the axial direction. Therefore, after the through holes 62c are inserted into the heat pipes 50 extending upward from the attachment portion 70, and the first layer (odd-numbered layer) of the fins 62-1 are arranged side by side in the circumferential direction, the second layer (even-numbered layer) of the fins 62-2 are shifted by a half pitch from the fins 62-1 in the circumferential direction, and the through holes 62c are inserted into the heat pipes 50. As a result, as illustrated in FIG. 6, the fins 62 in the fin portions 61 adjacent to each other in the axial direction are shifted by a half pitch from each other in the circumferential direction and overlap each other in the axial direction.

In a case where the fins 62 having the same shape in the fin portions 61 adjacent to each other in the axial direction overlap each other in the axial direction without being shifted in the circumferential direction, a sufficient gap may not be able to be secured between the fins 62 stacked in the axial direction. When the fins 62 in the fin portions 61 adjacent to each other in the axial direction are arranged to be shifted by a half pitch from each other in the circumferential direction, it is possible to secure a gap in the circumferential direction in each layer and a gap between the fins 62 adjacent to each other in the axial direction.

In a case where the central axis J is arranged in the horizontal direction in addition to obtaining the same operation and effect as those of the first example embodiment, the motor 1 of the present example embodiment can more efficiently dissipate the heat generated in the coil 30 by arranging the heat pipe 50 to penetrate the heat dissipation portion 60.

For this reason, in the electric airplane 100 including the motor 1, the rear cone portion 103 and the heat dissipation portion 60 can dissipate the heat generated by the motor 1 by the heat dissipation portion 60 having a large air cooling area and exhibiting a sufficient cooling performance while maintaining a rectification function of the backward flow by the rotation of the propeller 102b. Therefore, in the motor 1 mounted on the electric airplane 100, the limitation due to the temperature rise of the coil 30 is alleviated, and it is possible to greatly increase the power weight ratio and the maximum output of a continuous operation in the motor 1 of the same size and specification.

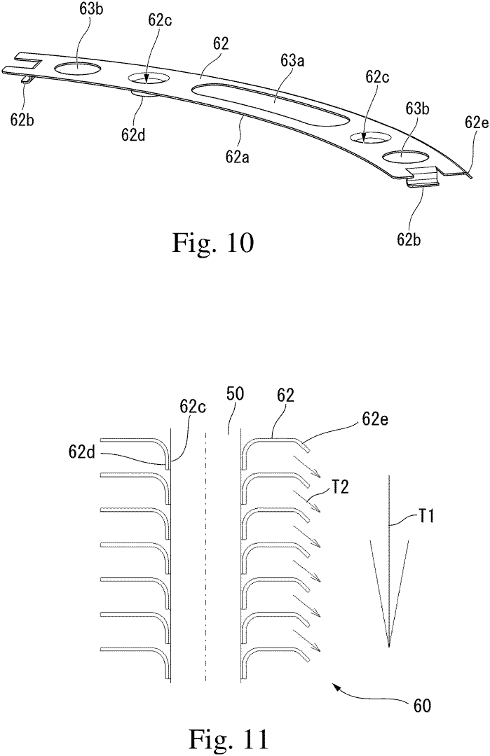

A modification of the second example embodiment will be described with reference to FIGS. 10 and 11.

As illustrated in FIG. 10, the fin 62 has a surface 62e and lightening portions 63a and 63b. The surface 62e is located on the outer periphery of the fin 62. The surface 62e is more inclined downward in the axial direction toward the radially outer side.

By providing the inclined surface 62e, as illustrated in FIG. 11, in the heat dissipation portion 60, an action, which is indicated by an arrow T2, of sucking out the internal air from the fin 62 is generated by the airflow indicated by an arrow T1 flowing outside the fin 62. Therefore, the air volume of the air passing through the inside of the motor 1 increases, so that the cooling efficiency can be increased.

The lightening portion 63a is a hole penetrating the fin 62. The lightening portion 63a has an arc shape extending from the circumferential center of the fin 62 to both circumferential sides as viewed in the axial direction. The lightening portion 63b is a hole penetrating the fin 62. The lightening portion 63b is arranged on the circumferential outer side of the through hole 62c. The lightening portion 63b is circular as viewed in the axial direction. The fin 62 can be reduced in weight by providing the lightening portions 63a and 63b in the fin 62. By reducing the weight of the fin 62, the cooling performance per weight of the fin 62 can be improved.

In the second example embodiment, the configuration in which the heat pipe 50 has a length from the housing 2 to the attachment portion 70 has been exemplified, but the present disclosure is not limited to this configuration. In a case where the heat pipe 50 is long, it may take time to assemble. In this case, a first heat pipe having a length from the housing 2 to the attachment portion 130 and a second heat pipe having a length from the heat dissipation portion 60 to the attachment portion 130 may be provided separately.

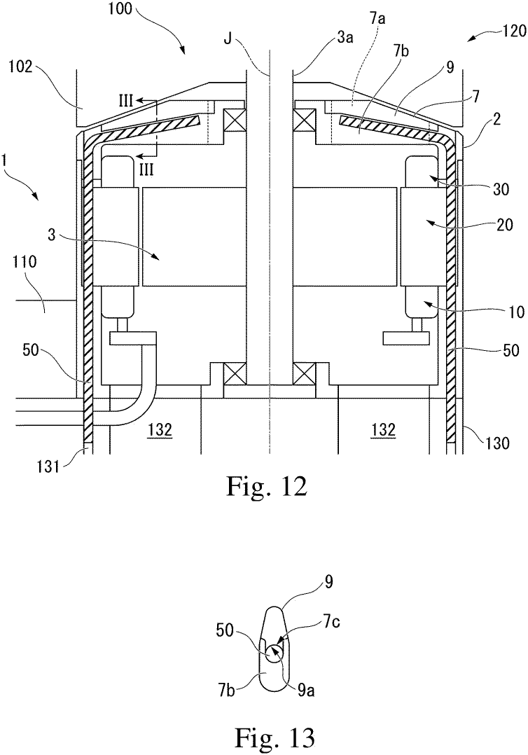

Next, a third example embodiment of the motor 1 will be described with reference to FIGS. 12 and 13.

In these drawings, the same elements as the components of the second example embodiment illustrated in FIGS. 5 to 11 are denoted by the same reference signs, and the description thereof may be omitted. In the motor 1 of the third example embodiment, the central axis J is arranged in the vertical direction.

As illustrated in FIG. 12, the rotary blade portion 102 has a recess 102d on the lower side facing the housing 2. The recess 102d tapers upward from the radially outer side toward the radially inner side. The lid portion 7 of the housing 2 in the motor 1 has a plurality of rib portions 7b. The circumferential position of the rib portion 7b is the same as the circumferential position of the hole HL. The through hole 7a is provided between the rib portions 7b adjacent to each other in the circumferential direction. The rib portion 7b is more inclined upward from the radially outer side toward the radially inner side.

As illustrated in FIG. 13, the rib portion 7b has a groove portion 7c extending in the radial direction. The groove portion 7c is open on the upper side. The bottom portion of the groove portion 7c has a semicircular cross-sectional shape. The diameter dimension of the bottom portion of the groove portion 7c is the same as the diameter dimension of the heat pipe 50. The rib portion 9 is fitted into the groove portion 7c from above. The rib portion 9 extends in the radial direction. The rib portion 9 has a groove portion 9a extending in the radial direction. The groove portion 9a is open on the lower side. The bottom portion of the groove portion 9a has a semicircular cross-sectional shape. The diameter dimension of the bottom portion of the groove portion 9a is the same as the diameter dimension of the heat pipe 50.

The heat pipe 50 has, on the upper side of the coil 30, a curved portion that bends to a radially inner side toward the upper side. In the heat pipe 50, the upper side from the curved portion linearly extends to be directed upward from the radially outer side toward the radially inner side. In the heat pipe 50, a region extending linearly above the curved portion is inserted into the groove portion 7c of the rib portion 7b. The lower side of the heat pipe 50 inserted into the groove portion 7c is held by the bottom portion of the groove portion 7c. The upper side of the heat pipe 50 inserted into the groove portion 7c is held by the bottom portion of the groove portion 9a in the rib portion 9. The rib portion 9 is fixed to the rib portion 7b with an adhesive. The upper side of the heat pipe 50 is fixed with an adhesive in the state of being held between the rib portion 7b and the rib portion 9. As the adhesive, an adhesive having a high thermal conductivity is used. In the heat pipe 50, the region held between the rib portion 7b and the rib portion 9 is a heat dissipation region.

In a case where the central axis J and the heat pipe 50 are arranged in the vertical direction, the influence of gravity acting on the working fluid in the heat pipe 50 is large. When the heat dissipation region of the heat pipe 50 is on the lower side, and the heat pipe 50 is long, it may be difficult for the working fluid liquefied in the heat dissipation region to move by the capillary structure. As illustrated in FIG. 12, the lower end of the heat pipe 50 is located in the attachment portion 130. Since the lower end of the heat pipe 50 is located in the attachment portion 130, in a case where the lower end of the heat pipe 50 is located in the heat dissipation portion 60, it is possible to suppress the liquefied working fluid from moving to the heat removal region.

In the heat pipe 50, the upper side from the curved portion linearly extends to be directed upward from the radially outer side toward the radially inner side, so that the heat dissipation region of the heat pipe 50 can be lengthened. The heat dissipation region of the elongated heat pipe 50 is located on the upper side. Therefore, the working fluid liquefied in the heat dissipation region can easily move to the lower heat removal region by its own weight.

Therefore, in the present example embodiment, in a case where the central axis J is arranged in the vertical direction, the heat generated in the coil 30 can be efficiently dissipated.

While the example embodiment of the present disclosure has been described above with reference to the accompanying drawings, it is obvious that the present disclosure is not limited to the example embodiment. Various shapes, combinations, and the like of the constituent members in the above example embodiment are only by way of example, and various modifications are possible based on design requirements and the like without departing from the scope of the present disclosure.

For example, in the above example embodiment, the configuration in which the fin portion 61 has the plurality of fins 62 obtained by equally dividing the fin portion in the circumferential direction has been exemplified, but the present disclosure is not limited to this configuration, and the fin portion 61 may be configured by one annular member.

Although not illustrated, a rectifying fin extending in the axial direction may be provided on the outer periphery of the heat dissipation portion 60. By providing the rectifying fins, the backward flow due to the rotation of the propeller 102b can be further rectified.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a rotor that is rotatable about a central axis; and
a stator that radially opposes the rotor with a gap interposed therebetween; wherein
the stator includes:
a stator core that includes an annular core back surrounding the central axis and a tooth extending to a radially inner side from the core back; and
a coil that is wound around the tooth; and the stator core includes:
at least one hole penetrating in an axial direction along the central axis; and
a slit that defines a space connecting the hole and a radially outer side of the stator core; and the motor further comprises:
a heat pipe that is held in the hole and extends in an axial direction along the hole; and
an adhesive that is between the hole and the heat pipe.

2. The motor according to claim 1, wherein a radially outermost position of the hole is on a radially inner side of an outer periphery of the stator core.

3. The motor according to claim 1, wherein a circumferential width of the slit is smaller than a diameter of the heat pipe.

4. The motor according to claim 1, wherein an adhesive is between the heat pipe and the coil.

5. The motor according to claim 1, further comprising:
a housing that accommodates the rotor and the stator; wherein
at least a portion of an axial end portion of the heat pipe is in contact with the housing.

6. The motor according to claim 1, further comprising:
a housing that accommodates the rotor and the stator; and
a heat dissipation portion that is on one side of the housing in the axial direction; wherein
the heat pipe penetrates the heat dissipation portion.

7. The motor according to claim 6, wherein the heat dissipation portion includes a plurality of layers of fin portions arranged in the axial direction.

8. The motor according to claim 7, wherein
the fin portion of each layer includes a plurality of fins obtained by equally dividing the fin portion in a circumferential direction; and
the fins in the fin portions adjacent to each other in the axial direction are shifted by a half pitch from each other in the circumferential direction and overlap each other in the axial direction.

9. The motor according to claim 8, wherein at least one of the fins includes, on an outer periphery, a surface more inclined to one side in the axial direction toward a radially outer side.

10. The motor according to claim 8, wherein, in the fin, a boss is provided at a penetrating portion of the heat pipe.
